(19) United States
(12) Patent Application Publication
(10) Pub. No.: US 2004/0093234 A1
(43) Pub. Date: May 13, 2004

(54) System for the organization of networking events

(76) Inventors: Debora L. Bondi, Wonder Lake, IL (US); Steven P. Smith, Crystal Lake, IL (US); Kent A. Welch, Wonder Lake, IL (US); Christopher S. Rowley, Lake Villa, IL (US)

Correspondence Address: Roland W. Norris, Pauley Petersen & Erickson, Suite 365, 2800 West Higgins Road, Hoffman Estates, IL, 60195, US

(21) Appl. No.: 10/698,768

(22) Filed: Oct. 31, 2003

Related U.S. Application Data
(60) Provisional application No. 60/422,678, filed on Oct. 31, 2002.

(51) Int. Cl. G06F 17/60

(52) U.S. Cl. 705/1

(57) ABSTRACT

A system for the organization of a networking event provides the electronic management of participant data and assignment of the participants into subgroups deemed most efficacious to achieve the purposes of the networking event. In certain embodiments the entire process for gathering of participant data and subgrouping of the participants may be done in a virtual environment. Certain embodiments may provide for additional management details of the networking event such as physical aspects including name tags, printed schedules and lists of subgroupings or participants, etc., as well as other aspects such as facilitating further contacts between participants, etc.

### BACKGROUND OF THE INVENTION

Networking events are events where people wishing to make contacts within a group of people can meet and share information. The attendees of a networking event are generally known as “participants.” The organizer of the event is generally known as the “sponsor.” A known example of a networking event is a physical meeting where the participants can gather, e.g., at tables, in subgroupings, with a series of subgroupings generally known as “rounds.” For example, small and medium size business owners from a particular geographic region may wish to make contacts among their peers to explore opportunities for utilizing each others' business goods or services. A sponsor of the event, e.g., such as a Chamber of Commerce within the locality, may arrange for the physical location and try to match participants into rounds of subgroups. It will be appreciated that such networking events are not limited to business participants, but could be ethnic associations, or social events or any group of similar interests which could produce subgroups of participants based on any generic or specific interests or data classifications serving as a classifier.

Networking events are very useful to sponsors, such as Chambers of Commerce, because the events can focus on the primary purpose of the organizations, e.g., to provide a means of business-to-business interaction. In addition, the events enable Chambers of Commerce or other networking organizations to grow and maintain membership through activation of new and existing members, to retain membership through introducing the membership to new prospective business clients, and encourage the recruitment of new members.

The matching of participants into groups is often intended to maintain groupings of generic compatible interests, avoid duplication of participants with specific similar businesses, or both. For example, if a plurality of participants are engaged in separate businesses involving specific similar businesses such as printing services, these participants likely will not wish to be grouped at the same table, thus decreasing the number of their potential business contacts. It would be desirable to schedule each of these participants at different tables for each different round. Groupings of generic compatible interests, e.g., participants doing business in a particular locality, may wish to meet others whose business is concentrated in that locality.

Sponsors have found that the manual preparation to ensure proper subgroupings and rounds of the participants is extremely laborious. Sponsors are often civic Chambers of Commerce with minimal staffing to organize all physical details of the event as well as ensure proper subgroupings of participants. A networking event of 100 participants may require many man-hours to ensure even minimally proper subgroupings of participants and the subgroupings may continually need to changed and updated as additional participants express interest in attending the networking event. Thus, there is a need to provide improved means for organizing a networking event to ensure that each participant is not placed in subgroupings where conflicting interests or duplication of similar interests exists.

### SUMMARY OF THE INVENTION

In response to the above-felt need, the present invention provides a system and method for organizing a networking event whereby participants are grouped electronically via one or more sorting algorithms according to classification criteria established for the networking event. According to aspects of the present invention either some or all of the details of the grouping of participants may be arranged by the system.

In one aspect of the present invention the sponsor is responsible for sending out registration forms to potential participants, or gathering responses, or both. In the case of physical forms, the sponsor may take completed forms and input into the system the names, business classifications and other classifier data of the participants that submitted a registration form. Alternatively, according to certain aspects of the invention, participants may directly access the system of the present invention via their individual computers, e.g., through a sponsor's website or a website specifically constructed for the networking event, and input their data and any payment electronically. In either case, participant information can be accumulated and managed with a known, or later developed, data entry/management application or applications.

When all participant data is input to the system database, an algorithm according to certain aspects of the invention may be used to produce a list of the participants and subgrouping round assignments for one or more rounds of subgroupings organized in a nonconflicting structure. One aspect of the present invention enables the system to generate a nonconflicting-business networking event by separating participants with the same classifiers, e.g., geographic location, type of service, or type of retail product, for the purpose of promoting and generating new referral leads and business to business contact.

In one aspect of the present invention software may sort through a database of participants and one or more of their participant classifiers. As participants sign up for the networking event, a database is created and includes data for each participant including participant identifiers, such as participant name, name of business, address, phone, and facsimile transmission (fax) numbers, linked to participant classifier data such as the participant's primary and secondary business category, e.g., advertising and marketing. From this data, the computer system, i.e., software and hardware, can assign a participant to a series of subgrouping rounds, e.g., to sit at a predetermined number of tables along with a specified number of other participants that have nonconflicting participant classifiers. The result is to minimize the duplication of the selected participant classifications at each sub-grouping of the event.

Further, according to another aspect of the invention, a scheduling algorithm will not place participants at the same table after they have met once. According to another aspect of the invention, if a participant classifier indicates that participants have met, or have likely met, prior to the networking event, e.g., are already members of a referral group (also sometimes called a “leads group”) who contact each other outside of the networking event, such participants will not be placed together. In another aspect of the invention, the number of rounds, or the number and type of participants in each subgrouping, or both, may be automatically reconfigured based on a desired configuration for the network event.

Aspects of the present invention can also be used for the matching of participants in smaller, more intimate networking events of, e.g., 100 attendees or less. Also, the number of participants in the subgroupings, or the number of subgroupings, or both, is not necessarily limited or fixed for a participant. The participants may, e.g., be matched individually into subgroupings for meetings with highly specific interest matches or no business category conflicts. Consequently, a more exact match of participant interests may be had. Participants may be scheduled to participate in one or more such small subgroupings of highly relevant classification matches within a networking event. Information from the subgrouping participants may then be forwarded, e.g., e-mailed or postal mailed, to the matched participants for future contact or follow-ups.

It will be appreciated that a virtual networking event taking place via electronic communication may also be possible. The matching, or grouping, of participants in a virtual networking event would be subject to the same constraints as set forth above.

### BRIEF DESCRIPTION OF THE DRAWINGS

FIG. 1 is an exemplary data input form useful for participant data collection to be used with the Participant Data Manager and its Participant Grouping Function according to one aspect of the present invention.

FIG. 2 is a block diagram of the basic operation of a system according to one aspect of the present invention.

FIG. 3 is a block diagram of the basic operation of an Event Coordinator Application according to one aspect of the present invention.

FIG. 4 is a schematic representation of the association of participant identifiers and associated data within a database according to aspects of the present invention.

FIG. 5 is a representation of options for the automatic reconfiguring of subgroup sizes or number of rounds according to aspects of the present invention.

### DETAILED DESCRIPTION OF PREFERRED EMBODIMENTS

Aspects of the present invention provide a system for organizing a networking event which provides a means to group participants electronically into subgroups, or series of subgroups, by utilizing one or more sorting algorithms according to classification criteria, i.e., participant classifiers, established for the networking event.

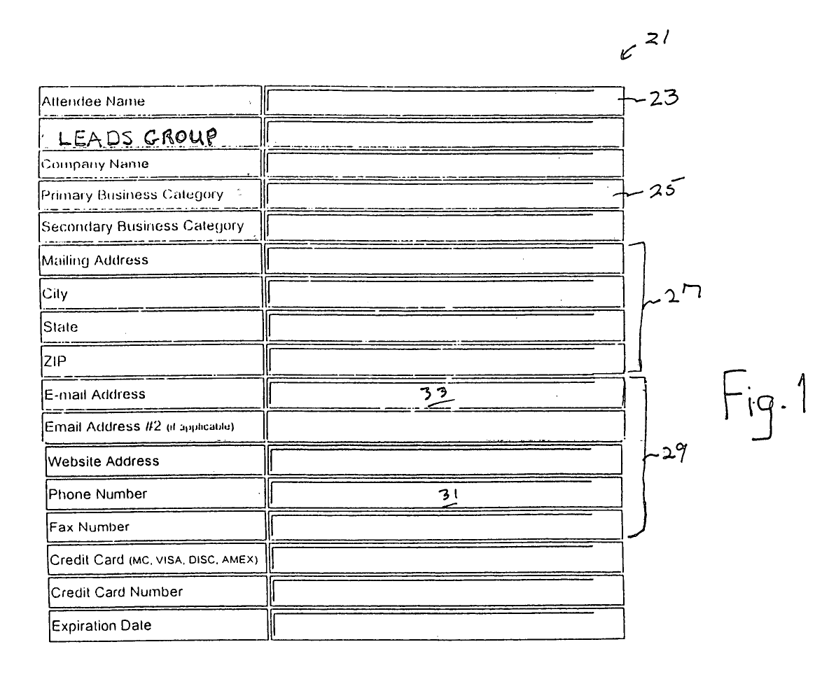

Referencing FIG. 1, in one aspect of the invention a registration form 21 is made available to potential participants. The registration form 21 requires that the participant input at least one identifier datum 23, e.g., an attendee name, and one participant classifier datum 25, e.g., a primary business classification. Other desirable information regarding the participant may be gathered including address information 27, contact information 29 such as phone numbers 31 and email addresses 33, some of which information may serve as further classifiers for subgrouping the event participants.

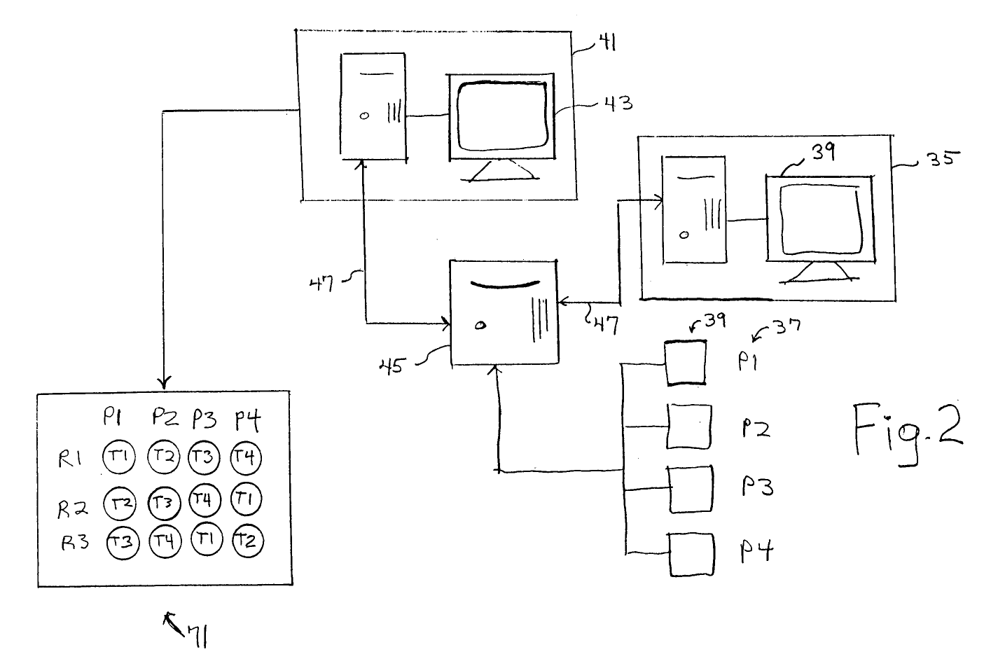

Referring also to the block diagram of FIG. 2, the sponsor 35 may be responsible for supplying physical registration forms or gathering responses, or both. Alternatively, the participants 37 (P1-P4) may fill in and return a virtual form, via their own computers 39, to the sponsor 35. The supply of forms and gathering of responses may be coordinated by the sponsor 35 via a pre-designed on-line input form 21 (FIG. 1) at a website 40 of the sponsor.

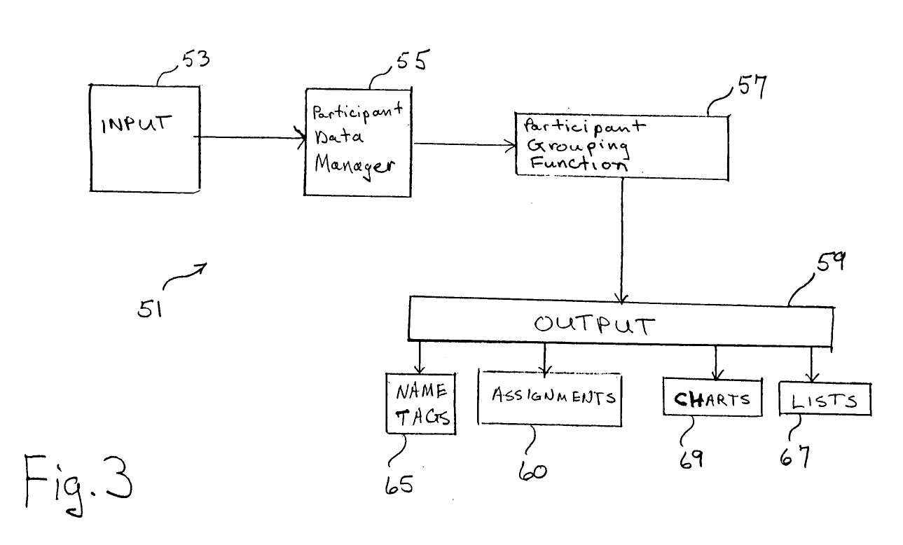

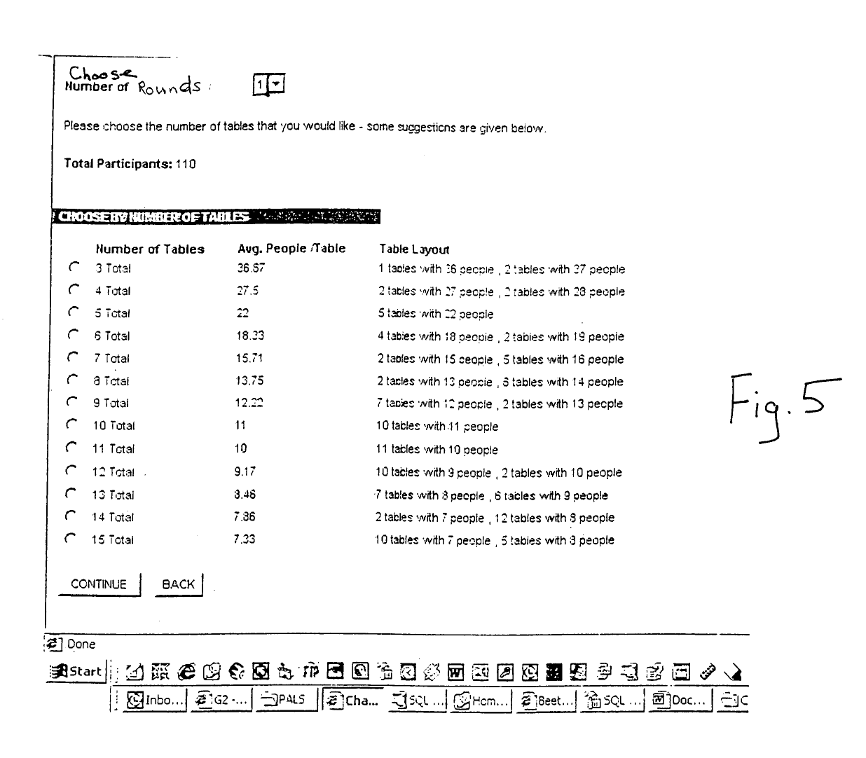

Alternatively, a data coordinator entity 41 which controls the Event Coordinator Application 51 (FIG. 3) may host a web site 43 which is linked to, or constructed within, the sponsor's web site 40. In the case of responses received on physical forms, the sponsor 35 may log onto a central server 45, e.g., via a website 43 belonging to the data coordinator entity 41, and input the names, business classifications and other participant data, as necessary, of the participants that submitted a registration form. For example, the sponsor 35 may be assigned, or chose, a user specific user name and password to enter participant data into a shared application or directly into a Participant Data Manager application 55 (FIG. 3) via a linkage 47 to the website 43 of the data coordinator entity 41. This link 47 may also be used for the sponsor 35 to enter relevant event data, such as the number of rounds and size of subgroupings desired (FIG. 5), or the selection of primary and secondary participant classifiers, or the like.

Alternatively, participants 37 may directly access a website of the data coordinator entity 41 and access the Participant Data Manager application 55 (FIG. 3) for a networking event via their individual computers 39, and input their data and any payment electronically. In either case, the participant information can be input and gathered through a data entry/management application such as MICROSOFT EXCEL, MICROSOFT ACCESS, or the like. Specific arrangement and set up of server linkages and websites is considered to be within the skill of the art and need not be further elaborated on. The sponsor 35 may continue to accept participant registrations until a time deadline or a number of participants limit is reached for the event.

Referring to FIG. 3, there is shown a block diagram of the Event Coordinator application 51. When all participant data is input 53 to the Event Participant Data Manager 55, e.g., a relational database such as MICROSOFT SQL, an algorithm of the Participant Grouping Function 57 according to certain aspects of the invention may be used to output 59 a list of the participant round assignments 60 for one or more rounds of subgroupings organized in a nonconflicting-classifier structure.

An exemplary pseudocode algorithm of the Participant Grouping Function 57 for the subgrouping of participants into each networking event round is as follows:

1) Place 1 facilitator at each subgroup. Those facilitators do not change subgroups for the duration of the networking event.

2) Order the remaining participants randomly.

3) Go through each participant in this random order and find the list of subgroups where there are no conflicts among primary business category (P), secondary business category (S), leads group (R), nor where there is anyone that person has met with before (L), i.e., condition (PRSL).

4) If the condition (PSRL) cannot be met, the program attempts to find the subgroup list with no conflicts in (PSL), i.e., condition (PSL).

5) If the condition (PSL) cannot be met, the program attempts to find the subgroup list with no conflicts in (PS), i.e., condition (PS).

6) If the condition (PS) cannot be met, the program takes the list of subgroups with open places remaining.

7) A subgroup is randomly selected from the list of subgroups found in steps 3)-6).

8) The algorithm repeats from step 3) until all participants are placed at a subgroup.

9) The algorithm repeats from step 2) for each round in the event.

Thus, one software aspect of the present invention can generate a nonconflicting-business networking event by separating participants with the same classification, type of service, or type of retail product, for the purpose of promoting and generating new referral leads and business to business contact.

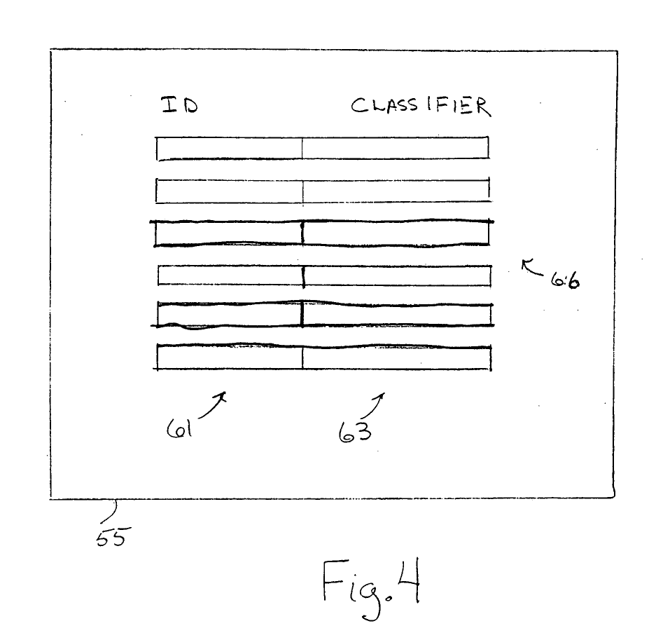

Referring to FIG. 4, the software sorts through a database of participant identifiers 61 and one or more of the business classifiers, collectively 63, associated with the identifiers 61. As participants sign up for the networking event, a database 66 is created in the Participant Data Manager Function 55 and includes the identifier information 61 such as their name, name of business, address, phone, fax, and classifier data 63 such as their primary and secondary business categories, e.g., advertising and marketing. It is noted that some identifier information 61 may also be used as classifier data 63, e.g., phone number area codes, prefixes, or the like. From this data, the Participant Grouping Function 57, typically a computer program, i.e., software, can, e.g., assign a participant to sit at a predetermined number of tables along with a specified number of other participants that have different business classifications. The result is to minimize the duplication of participant business classifications at each subgroup and provide participants with referral leads that are not in competition with their own business. For example, as seen in FIG. 2, the output of the data coordinator entity 41 may be illustrated by a grid 71 of four participants, P1-P4, with conflicting classifiers, who are placed in three rounds R1-R3 at different tables, T1-T4, i.e., subgroupings, for each round.

In the exemplary pseudocode above, it will be noted that four different classifiers are used to determine participant placement within a subgroup. Primary and secondary business categories, leads group membership, and, in the case of serial rounds, whether the participants have been matched into the same subgroup in previous rounds. It will be noted that if all participant classifiers cannot be grouped without conflict, the Participant Grouping Function 57 will iterate to achieve the maximum number of nonconflicting participant classifiers for a subgroup. Further, it will be appreciated by those of skill in the art that while the Participant Grouping Function 57 has been presented in terms of conflict avoidance, the code may be written to perform groupings of similar generic interests of the participants, e.g. locality of business, in addition to conflict avoidance.

Further, according to another aspect of the invention, a scheduling algorithm will not place participants at the same table after they have met once. According to another aspect of the invention, if data indicates that participants have met, or have likely met, prior to the networking event, e.g., are already members of a referral group, also sometimes called a “leads group,” which contacts each other outside of the networking event, such participants will not be placed together. Other aspects of the present invention can also be used for the matching of participants into a more flexible format of subgroupings. The number of participants in the subgroupings, or the number of subgroupings, or both, is not necessarily limited or fixed for a participant. The participants can, e.g., be matched for smaller subgroupings to create meetings with minimal business category conflicts. Consequently, a more exact match of participant interests may be had. Participants may be scheduled to participate in one or more such small subgroupings of highly relevant classification matches within one networking event. Information from the subgrouping participants might then be forwarded, e.g., e-mailed or postal mailed, to the matched participants for future contact or follow-ups.

It will be appreciated that a virtual networking event taking place via electronic communication may also be possible. The matching, or grouping, of participants in a virtual networking event would be subject to the same constraints as set forth above.

In one aspect of the invention, at the beginning of the sign-on process the sponsor 35 will be asked to enter the date of the event, time of the event, location of the event, and the cost of the event into the data coordinator entity's Event Coordinator Application 51. This data may be used according to one aspect of the present invention to create a registration form for the sponsor to make available to their membership, whether electronically or physically.

With reference to FIG. 3, when all the participant data is input, the Event Coordinator Application 51, according to some aspects of the invention, may act as a full service event planner that may, for example, output nametags 65, lists 67 which may include the participant's table assignments or other information, produce specifically tailored or general attendee lists to give to the participants, produce informational charts 69 concerning the demographic or statistical data of the event, and produce charts or lists of participants and rounds, e.g., which table the participants are sitting at or various desired forms of subgroup schedules, for each round of the event.

With reference also to FIG. 5, when all the participant data is input, the Participant Grouping Function 57 according to some aspects of the invention may act to automatically reconfigure the number of subgroupings and rounds, and the number or type of participants or both, within the networking event, according to selection criteria imposed by the sponsor.

It will be realized by the person having ordinary skill in the art that while the present invention has been exemplified as a system for the organization of business networking events, other applications of the present invention are possible, and variants and alternatives may be realized within the spirit and scope of the present invention. The person having ordinary skill in the art will appreciate that there has been described an exemplary embodiment. It will recognized that many of the functionalities described herein can be accomplished by a variety of hardware, firmware and software methods and associated apparatus within the scope of the present invention.

We claim:

1. A method for the organization of participants within a networking event, comprising:
storing a list of participant identifiers for a group of participants in an electronic database;
associating a participant classifier with each participant identifier on the list of participant identifiers;
electronically arranging the participants according to the participant classifiers into subgroupings, each subgrouping having non-conflicting participant data classifiers among the participants within the subgrouping.

2. The method for the organization of a participants within networking event according to claim 1, further comprising:
arranging the participants into serial, non-repeating, rounds of subgroupings.

3. The method for the organization of a participants within networking event according to claim 2, further comprising:
automatically reconfiguring the number of subgroupings or rounds, or both, within the networking event, according to selection criteria imposed by the sponsor.

4. The method for the organization of participants within a networking event according to claim 1, further comprising:
each participant having a primary classifier and a secondary classifier.

5. The method for the organization of participants within a networking event according to claim 1, further comprising:
arranging nonconflicting participant data classifiers of a subgrouping according to at least one of:
a) grouping classifiers of compatible generic interests, and
b) avoiding duplication of classifiers of similar specific interests.

6. The method for the organization of participants within a networking event according to claim 5, wherein:
the generic interests are business types.

7. The method for the organization of participants within a networking event according to claim 5, wherein:
the specific interests are business types.

8. The method for the organization of participants within a networking event according to claim 5, wherein:
wherein the generic interests are geographic location.

9. The method for the organization of participants within a networking event according to claim 5, wherein:
the specific interests are geographic location.

10. The method for the organization of participants within a networking event according to claim 1, including the further step of:
developing a data collection form for gathering the participant data.

11. The method for the organization of participants within a networking event according to claim 1, further comprising
managing participant data for informational purposes including one of name tags, subgroup schedules, and participant lists.

12. A method for the organization of participants within a networking event, comprising:
a) receiving a time and location for a networking event from a sponsor;
b) providing a registration form to capture participant data comprising a participant identifier and a primary classifier for each participant;
c) entering the participant data into an event coordinator application including a participant data manager for entering, managing and storing participant identifiers and participant classifiers in a database, and a participant grouping function; and
d) electronically developing, with the participant grouping function, subgrouping assignments of participants having non-conflicting participant data classifiers among the participants within each subgroup.

13. The method for the organization of participants within a networking event according to claim 12, wherein:
each of steps of claim 12 a)-d) are performed electronically.

14. The method for the organization of participants within a networking event according to claim 12, wherein:
each of steps claim 12 a)-d) are performed through a data coordinator entity web site.

15. The method for the organization of participants within a networking event, according to claim 12, wherein:
the participant grouping function is described in pseudocode as:
a) place the participants in a random order;
b) go through each participant in the random order and find a list of subgroups where there are no conflicts among primary business category (P), secondary business category (S), nor where there is anyone two persons that have met before (L);
c) if condition (PSL) cannot be met, attempt to find a subgroup list with no conflicts in (PL);
d) if condition (PL) cannot be met, attempt to find a subgroup list with no conflicts in (SL);
e) if condition (SL) cannot be met, attempt to find a subgroup list with no conflicts in (PS);
f) if condition (PS) cannot be met, select a list of subgroups with open places remaining;
g) a subgroup is randomly selected from the list of subgroups found in steps c)-f);
h) repeat algorithm from step c) until all participants are placed at a subgroup;
i) repeat algorithm from step b) for each round in the network event.

16. The method for the organization of participants within a networking event according to claim 12, further comprising:
managing participant data for informational purposes including one of name tags, subgroup schedules, and participant lists.

17. A method for the organization of participants within a networking event, comprising:
a) receiving a time and location for a networking event from a sponsor;
b) providing a registration form to capture participant data comprising a participant identifier and a primary classifier and a secondary classifier for each participant;
c) entering the participant data into an event coordinator application including a participant data manager for entering, managing and storing participant identifiers and participant classifiers in a database, and a participant grouping function; and
d) electronically developing with the participant grouping function subgrouping assignments of participants having non-conflicting participant data classifiers among the participants within each subgroup; and
e) outputting the subgrouping assignments.

18. The method for the organization of participants within a networking event according to claim 17, wherein:
each of steps of claim 17 a)-d) are performed electronically.

19. The method for the organization of participants within a networking event according to claim 18, wherein:
each of steps claim 17 a)-d) are performed through a data coordinator entity web site.

20. The method for the organization of participants within a networking event, according to claim 19, wherein:
the participant grouping function is described in pseudocode as:
a) place the participants in a random order;
b) go through each participant in the random order and find a list of subgroups where there are no conflicts among primary business category (P), secondary business category (S), nor where there is anyone two persons that have met before (L);
c) if condition (PSL) cannot be met, attempt to find a subgroup list with no conflicts in (PL);
d) if condition (PL) cannot be met, attempt to find a subgroup list with no conflicts in (SL);
e) if condition (SL) cannot be met, attempt to find a subgroup list with no conflicts in (PS);
f) if condition (PS) cannot be met, select a list of subgroups with open places remaining;
g) a subgroup is randomly selected from the list of subgroups found in steps c)-f);
h) repeat algorithm from step c) until all participants are placed at a subgroup;
i) repeat algorithm from step b) for each round in the network event.

21. The method for the organization of participants within a networking event according to claim 20, further comprising:
organizing participant data for informational purposes including outputting at least one of name tags, subgroup schedules, and participant lists.
